(19) United States
(12) Patent Application Publication
(10) Pub. No.: US 2011/0238381 A1
(43) Pub. Date: Sep. 29, 2011

(54) Data Management System

(75) Inventor: Don E. Edwards, Richland, WA (US)

(73) Assignee: RANDOLPH CONSTRUCTION SERVICES, INC., Pasco, WA (US)

(21) Appl. No.: 12/748,065

(22) Filed: Mar. 26, 2010

(51) Int. Cl. G06F 15/00

(52) U.S. Cl. 702/188

(57) ABSTRACT

The invention a data management system comprising: a) a data input interface capable of receiving a plurality of data streams pertaining to a surveillance event, wherein said data streams are derived from more than one data-generating collector; b) data storage means capable of storing data from said plurality of data streams; c) data analysis means capable of analyzing said data to characterize said event; and d) a consumer interface capable of outputting said data in human recognizable form, wherein said data input interface is configured to accommodate more than one dissimilar data streams from said more than one data-generating collectors.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files and records, but otherwise reserves all other copyright rights.

### BACKGROUND OF THE INVENTION

1. Field of the Invention

This invention relates to the collection, storage, management and efficient presentation of surveillance data and is specifically directed to a comprehensive security surveillance system used to monitor cargo passing through ports-of-entry as part of the Second Line of Defense program administered by the National Nuclear Security Administration of the United States of America.

2. Description of Related Art

With the collapse of communist regimes, that previously maintained nuclear arsenals, and the rise of global terrorism, the United States and its international partners have become concerned about the transportation of radioactive materials that could be used to create weapons of mass destruction or radiation dispersal devices. Addressing this concern, it is the mission of the Second Line of Defense (SLD) program, administered by the National Nuclear Security Administration (NNSA), to strengthen the capability of foreign governments to deter, detect, and interdict illicit trafficking in nuclear and other radioactive materials across international borders and through the global maritime shipping system. Under this program, the NNSA works collaboratively with foreign partners to equip border crossings, airports and seaports with radiation detection equipment and associated communication systems that allow the screening of cargo containers for nuclear and other radioactive materials. It is the goal of the Second Line of Defense program to equip over five-hundred border crossing points in thirty-two countries by 2011 and over one hundred seaports, scanning approximately fifty percent of global shipping, by 2015.

One of the challenges in executing the SLD program has been the creation of a comprehensive surveillance data interface and management system, known within the SLD program as the Central Alarm Station (CAS) Communication System. Because of the magnitude and international nature of the program, a CAS Communication System has several requirements. Such a system must be scalable across a wide range of potential installations, from simple border stations to complex shipping ports, and such scalability must be accomplished with minimal or no redesign and without loss of functionality.

In addition, multiple different kinds of systems are used to perform the monitoring that is contemplated by the SLD program including, radiation isotope identification devices, non-intrusive imaging systems, radiation portal monitoring systems, terminal operating systems, optical character recognition systems and similar surveillance systems existing now or that may be developed in the future. Each of these systems (data-generating collectors) has varying interface requirements, produces varying types of data, and requires differently configured data timing, generation and receipt schemes. Moreover, for each type of data-generating collector there may be multiple manufacturers using varying interfaces and data delivery solutions. Because one of the goals of the SLD program is to collaborate with foreign partners and those partners may wish to use varying equipment manufacturers, a CAS Communication System must employ a vendor and device neutral interface and data management scheme that requires minimal or no redesign or recoding upon the addition of a new data-generating collector.

The data generated by the various types of data-generating collectors must be provided in a common effective and intuitive user operable interface configured to allow for efficient real-time review of data so as to allow for a timely response. The system must allow for the storage and retrieval of all data generated by data-generating collectors and, due to the number of sites contemplated and their varying size, must allow for the user interface to be geographically remote from the site at which data is collected.

In addition to these requirements, a CAS Communication system must be secure, insuring that all data collection inputs are authenticated and authorized so attempts to circumvent, disrupt or deny the service provided by the system are unsuccessful. A CAS Communication system must also be reliable, operating at all times and able to manage the intake and recording of data in a way that prevents the need to take the system offline at any time. Finally, the system must be cost effective, both minimizing the cost of ownership and operation, and allowing for the incorporation of pre-existing hardware and software systems.

Previous attempts to provide a data management and interface system addressing challenges similar to those of a CAS Communication System appear in both the security and process control fields. One such system, from the security field, is the Radioactive Alarm and Video Event Notification II system (RAVEN II) offered by TSA Systems, Ltd. and detailed in that company's product flyer dated June 2007 and entitled “Monitoring Solutions.” Under the RAVEN II system, one or two data-generating collectors are organized along with a data concentrator, a detector controller and a media convertor into discreet systems having a single data stream. These data streams feed into a data interface that may handle the output from up to sixteen such systems. The RAVEN II system does not provide for the easy interchange of data-generating collectors from different manufactures or the interchange of differing types of data-generating collectors. Hence, the owner of the RAVEN II system may be limited to acquiring data-generating collectors from a single source or extensively modifying the system to accommodate different data-generating collectors. The RAVEN II system is limited in capacity to a set number of systems and, therefore, a set number of data-generating collectors. The recording capabilities of the RAVEN II system are unclear and, specifically, it is not clear that such a system reliably provides constant collection of data over the long term.

U.S. Pat. No. 6,545,601 B1, issued to Monroe on Apr. 8, 2003 entitled “Ground Based Security Surveillance System for Aircraft and Other Commercial Vehicles”, discloses a data management and interface system directed toward monitoring and maintaining the security of commercial aircraft while on the ground at an airport. While the disclosed system claims the ability to manage, record and present the input from a wide variety of sensors in a secure manner, Monroe does not claim the ability to easily convert between sensors from a variety of manufacturers without significant and costly modification to the management system. Further, while the system is designed for a large number of inputs, it does not appear scalable, enabling support for both small and large applications without redesign. Finally, the system does not provide for the minimization of costs, such as allowing for the use of pre-existing hardware.

Data management and interface systems used for process control have limitations similar to those designed for security systems. The Vijeo Citect Supervisory Control and Data Acquisition (SCADA) software offered by Schneider Electric is typical of such systems. This system is described in the product flyer dated February 2007, entitled “SCADA software Vijeo Citect, Producing your great achievements.” The Vijeo Citect system is intended to allow remote monitoring and control of an industrial process and its advertisers claim that the system is scalable so as to allow use either in a single plant or in multiple locations on different continents. The system, however, is primarily designed to be integrated with its manufacturer's electronic equipment (data-generating collectors). To achieve interchangeability, the system relies on “third-party drivers” that may or may not be available for the data-generating collectors a particular user wishes to install. Using such a single manufacturer centered system leads to the potential of incompatibility and fails to achieve the collaboration goal of the SLD program.

As demonstrated by these examples, systems developed in the past to manage surveillance data, including those directed toward security as well as those directed toward other endeavors, like process control, would fail to meet the rigorous demands expected of a CAS Communication system. This is primarily due to an engineering approach that allows the particular data-generating collector to dictate the format and structure of the entire data management and user interface system. The present requirements of a CAS Communication have, therefore, required a new engineering approach.

### SUMMARY OF THE INVENTION

This invention provides a data management system that includes a data input interface, able to receive several data streams pertaining to a surveillance event from more than one data-generating collector. The data input interface is configured to accommodate more than one dissimilar data stream from the data-generating collectors. The system includes a data storage means, such as a hard drive, capable of storing data from the data streams and a data analysis means, such as a microprocessor with software code, capable of analyzing the data to characterize the surveillance event. The system also includes a consumer interface that can output the data in human recognizable form.

The invention provides, in alternative embodiments, that the consumer interface may be configured to adjust the output of data for the dissimilar data streams, may be adapted to automatically output the data from a new data stream or may be configured to adjust the output in some recognizable form. In another embodiment, the system has a business logic component that can determine the form of the output data. In further embodiments, the input communication interface could be modular and this modular interface could accept data streams from additional data-generating collectors. The input communication interface could also be designed to accommodate many different data-generating collectors of different type or manufacture.

In alternative embodiments, the event to which the data pertains could be the passage of a container through a port-of-entry or could constitute a step in a process. The data-generating collectors could comprise at least one collector of sensed data and the sensed data could relate to a sensed attribute of a cargo container. The data-generating collectors could include a radiation identification device, a non-intrusive imaging device, a radiation portal monitor system, a terminal operating system, or an optical character recognition system. The analysis of data could include the comparison of two or more of the data streams and the resulting characterization could relate to the security risk associated with the event.

The invention also provides that the means of storing data, such as a hard drive, could be geographically remote from the data-generating collector. The system may be designed to accommodate data-generating collectors differing in type or manufacture and may be further designed so that the addition of any new or different data-generating collector requires modification of less than ten percent, or even five percent, of the system software. The system may further be scalable from utilization of a single data-generating collector to utilization, in different embodiments, of up to ten, fifty, a hundred or a thousand data-generating collectors.

The invention also contemplates a method for managing data streams produced by components of a system having multiple dissimilar data-generating collectors. This method includes generating data from a communication interface that is capable of receiving a plurality of data streams that pertain to a surveillance event. The data streams originate with multiple data-generating collectors. The method also includes loading the generated data into a data storage means capable of managing the data from the multiple data streams, such as a hard drive, and analyzing the data to characterize at least one detected attribute relating to the surveillance event.

In alternative embodiments, the method may incorporate further methods or utilize apparatuses similar to those described for the system.

These and other features and advantages of this invention are described in, or are apparent from, the following detailed description of various exemplary embodiments of the apparatus and methods according to this invention.

### BRIEF DESCRIPTION OF THE DRAWINGS

A more complete understanding of the present invention and the attendant features and advantages thereof may be had by reference to the following detailed description when considered in conjunction with the accompanying drawings wherein:

FIG. 1 shows a diagram of the architecture and various components of the data interface and management system of the invention.

FIG. 2 shows a flow diagram graphically describing the operation of the data interface and management system of the invention.

### DETAILED DESCRIPTION OF THE INVENTION

The present invention provides a novel and improved plug-in, or modular, CAS Communication System, and method for managing surveillance data (the CAS Plug-In System).

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely”, “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

In this description, the term “CAS Communication System” means a Central Alarm Station (CAS) communication system, which is capable of the command and control of a single or multiple external systems for the purpose of oversight, analysis, decision making, or response to sudden or changing events. In this description, the term “CAS Plug-in System” means a modular system framework that provides the means to connect to an external system, receive data from said system, transmit data to such a system, and or to transmit external system information to a User Interface.

In this description, the term “data-generating collector” means any device, series of devices or system capable of collecting data pertaining to an object or an event, whether that data be in analog or digital form, and includes such devices as cameras, temperature detectors, radiation detectors, radiation identification devices; radiation portal monitor systems, terminal operating systems, and optical character recognition systems.

By “data stream” is meant a stream of data, either continuous or intermittent, produced by a data-generating collector.

By “event” is meant any occurrence or unexpected non-occurrence of interest to the user of the system or method of the invention.

The term “characterize” is intended to be broadly construed and includes the result of any comparison of data concerning an event to expected, predicted or prior data and would include anything from a report of that comparison to the triggering of an alarm or an alert.

The term “container” is intended to be broadly construed and includes anything that may pass through a port-of-entry which could contain an item, including a shipping container, but also any type of vehicle, personal luggage, or the pocket of an article of clothing.

The term “step in a process” is intended to be broadly construed and includes any portion of any process, including industrial manufacturing processes, which the user of the invention may wish to monitor.

By “modification” is meant the change to any of the hardware, the software, or a combination thereof that comprises the system.

Numerous other common acronyms known the art are used in the attached description or drawings, which are known to the art. Still, and for the avoidance of doubt, the following key is provided for the acronyms used, as found in the following table:

TABLE 1
Acronyms/Abbreviations

| | |
|---|---|
| CAS | Central Alarm Station |
| CSI | Container Security Initiative |
| C# | C Sharp |
| DOE | Department of Energy |
| ICD | Interface Control Description |
| LPR | License Plate Reader |
| NCS | National Communication System |
| NID | Network Inspection Device |
| NNSA | National Nuclear Security Administration |
| OCR | Optical Character Recognition |
| RAVEN II | Radioactive Alarm and Video Event Notification II |
| RCS | Randolph Construction Services, Inc. |
| RIID | Radioactive Isotope Identification Device |
| RPM | Radiation Portal Monitor |
| RS-422 | American national standard ANSI/TIA/EIA-422-B |
| RS-423 | RS/EIA/TIA-423 is a standard for serial communications. |
| SCADA | Supervisory Control and Data Acquisition |
| SFI | Secure Freight Initiative |
| SLD | Second Line of Defense |
| SNMP | Simple Network Management Protocol |
| SOP | Standard Operating Procedure |
| SPM | Spectroscopic Portal Monitor |
| SQL | Structured Query Language |
| TOS | Terminal Operating System |
| TSA | TSA Systems Ltd |
| UI | User Interface |
| UPS | Universal Power Supply |
| USB | Universal Serial Bus |
| XML | Extensible Markup Language |

The design of the CAS Plug-In System and method is not driven by the design of any particular data-generating collector, but treats the data-generating collectors as interchangeable “plug-in” devices, the data streams of which are translated and fed into the core of the system. This unique architecture results in a system that is neutral with respect to any data-generating collector so that the user may freely interchange different kinds of devices and devices of differing manufacture with little or no change to the core system.

This architecture also provides the advantage of scalability, so that the user is not limited by any maximum number of data-generating collectors. Moreover, the same modular, or “plug-in”, architecture that is used for data-generating collectors is used for other portions of the system, including those portions that receive data from the system, such as data storage devices and human interfaces. This architecture provides great flexibility in the way data may be presented and stored.

Although in one embodiment the invention is directed toward providing a solution to the unique requirements of the CAS Plug-In System, the system is applicable to any application wherein the user wishes to systematically monitor events, react to events, or needs to quickly interface to external interfaces. It is also applicable to applications that require a rapid integration of new or dissimilar systems to an ongoing operation. This may occur in research organizations that require the ability to quickly prototype a design to validate a hypothesis. Another example would be manufacturing sites that require the ability to introduce temporary controls to an automated valve, non-destructive testing, and/or assembly line control.

The CAS Plug-In System and the associated development environment can largely be assembled from commercially available software and open standards. In assembling the components, proprietary and outdated technologies are avoided. In essentials, the CAS Plug-In System includes a data storage means, generally a computer hard drive, though the data storage means also constitutes equivalents of this structure.

Data analysis means can include a microprocessor and software code sufficient to cause that microprocessor to compare data from a data-generating collector against previously stored parameters to characterize that data. The data analysis may further include hardware or software equivalents of these structures.

The software development environment preferably utilizes the .Net development toolkit, using C# (C Sharp) programming language. The SQL database uses stored procedures and database triggers to provide the means of data archive, retrieval, and applies Plug-In specified business logic and rules, this in turn is displayed to the operator via the user interface.

The Data Store also houses specific tables of the interface specific configurations within the CAS Plug-In System. An XML based Schema definition defines the interface requirements of the CAS Plug-In System. This provides the means for third-party equipment and system vendors to produce their own Interface Plug-In for the CAS System or to be produced by any interested party.

For making a design plug-in, three pieces can be used in a simple configuration logic system:

1) a device plug in to the system-data interface configuration;

2) a user display interface, i.e., how to display and what to display; and

3) a business logic component, i.e., what rules or events should occur if any given input is received from the device plug in.

The business logic component defines issues of what form of data may or may not even be displayed, computations, rules, logic, based on the configuration for that surveillance type.

This is a plug-in concept, where the input and output are pre-designed for a variety of dissimilar streams, and optimized for the usefulness of the display to the consumer.

As part of the business rules, Boolean logic is applied, to allow situations where a consumer requires the ability to have decisions made, provide alerts to operators, or to send information or control logic back to the external interface. Such optimizations may comprise issues relating to what confidence level deserves a warning, for example. Such issues are unrelated to hardware code. Rather, these are decisions and or actions based upon the inputs received related to confidence numbers and warning levels and the like, i.e., the underlying business logic component are integrated and allow selection of levels by the consumer.

Another example of such an add-on, but not a source code issue, would be allowance for the consumer to select a language plug in.

That being said, most common data protocols and data systems will already be included, such as through defaults.

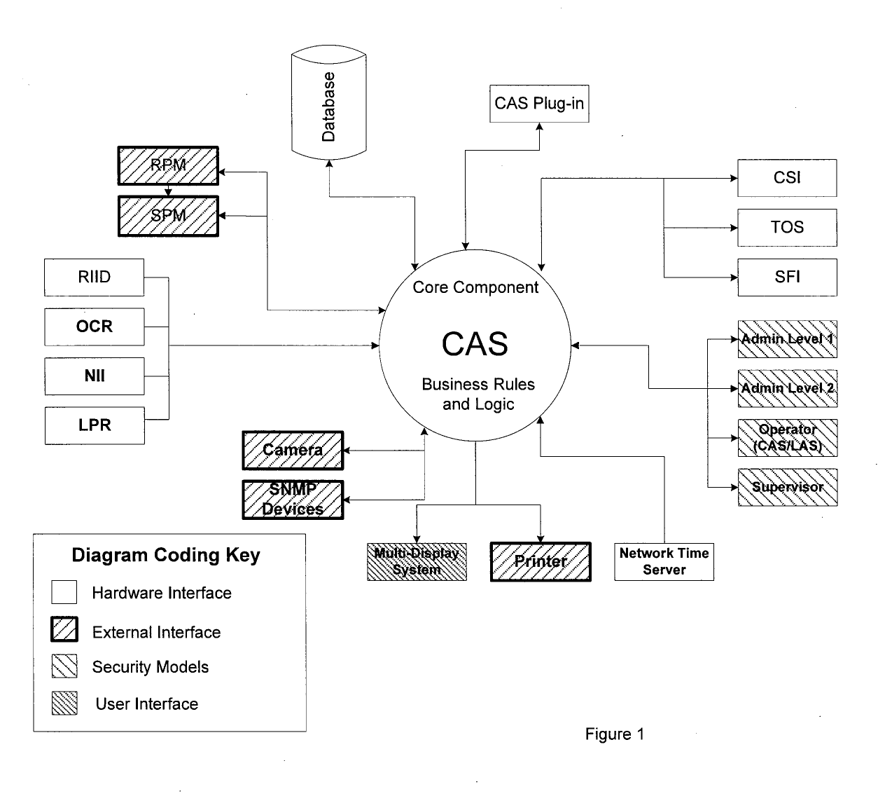

As shown more particularly in reference to FIG. 1, which shows a CAS Context Diagram, the CAS Plug-In System is comprised of a central Data Store, Communication Interface (Core Component), interface specific Plug-Ins that provide external and Internal Interfaces, Security Models, and the User Interface. The Data Store utilizes the commercially available Microsoft SQL Server and can support both the Enterprise or Standard editions.

The Core Component is responsible for applying the overall business rules and logic. Even though the Hardware and External interfaces are depicted using different shade coding, the architecture is the same as far as the CAS System is concerned. Both the Core Component and Plug-In interfaces are developed using the .Net framework and C Sharp (C#) programming language. This choice of development environment and programming language provides an environment that is well established, stable, efficient, and widely used in the industry. As such, it facilitates the rapid development and support available for new external interface design and development.

The Plug-In interfaces are responsible for accessing the remote system or hardware device using the manufacturers Interface Control Description (ICD). The ICD provides the information necessary to understand the external systems input and output requirements. At a minimum, the ICD provides the protocol(s), message format, input and output requirements, and definitions of these input/outputs.

The CAS System Plug-In interface has been architected to allow for multiple instances of any given Plug-In. This allows for the re-use of a CAS Plug-in for other external interfaces without the need to reproduce another Plug-In. For example, if there are multiple but identical external interfaces, then only one instance of the Plug-In is necessary to be developed, which in turn can be called multiple times. Additionally, this allows for using a Plug-In that was written for Interface A for Interface B, so long as Interface B supports the interface Plug-In (i.e., external interfaces that support RS-422, RS-423, USB 2.0 etc.)

In turn, the Plug-In interface then utilizes the CAS Plug-In System specific ICD for communication to and from the central Core Component. This concept is new and unique to the CAS System architecture. For example, it is common for other similar systems to use a Plug-In architecture to interface with external systems, but not common to use this same Plug-In to provide data normalization to the host system, e.g., the CAS System. The CAS System Plug-In translates the external device data to the correct format, i.e., that to be used by the CAS System.

Since all external device Plug-Ins now communicate in a single, known format to the core CAS Components, little or no changes to the Core system is necessary as new external devices are integrated. This also provides great benefit in the User Interface, Business rules and logic, and various efficiencies that go directly to the ability to scale the system to the specific client.

As will be apparent from FIG. 1, the manner of the application of the present Plug-In approach is unprecedented for a CAS Plug-In System of this type. No other similar system has implemented this approach. This is evident in the design due to the fact the security models, User Interface, and time services are treated as external interfaces. Most software systems provide these types of services within the Core Component. Each Plug-In execution space is not hardware dependant, and so each Plug-In, or any combination thereof, can operate on different computer platforms within the accessible network.

As the Plug-Ins are capable of being run on external computer systems, the CAS Plug-In System allows for a highly scalable system that reduces or removes the need to re-code the Core Component, User Interface, Security Models, or Data Store structures when additional interfaces are built.

The addition of other interfaces to external devices and systems will change in the future. To allow for client-specific security models, display requirements, time services used, and user interface customization, the CAS Communication system is authored to treat these as interfaces. Present systems build these capabilities into the Core Component, making future modifications a significant endeavor, reducing efficiencies and scalability, and increasing cost and time to release to market.

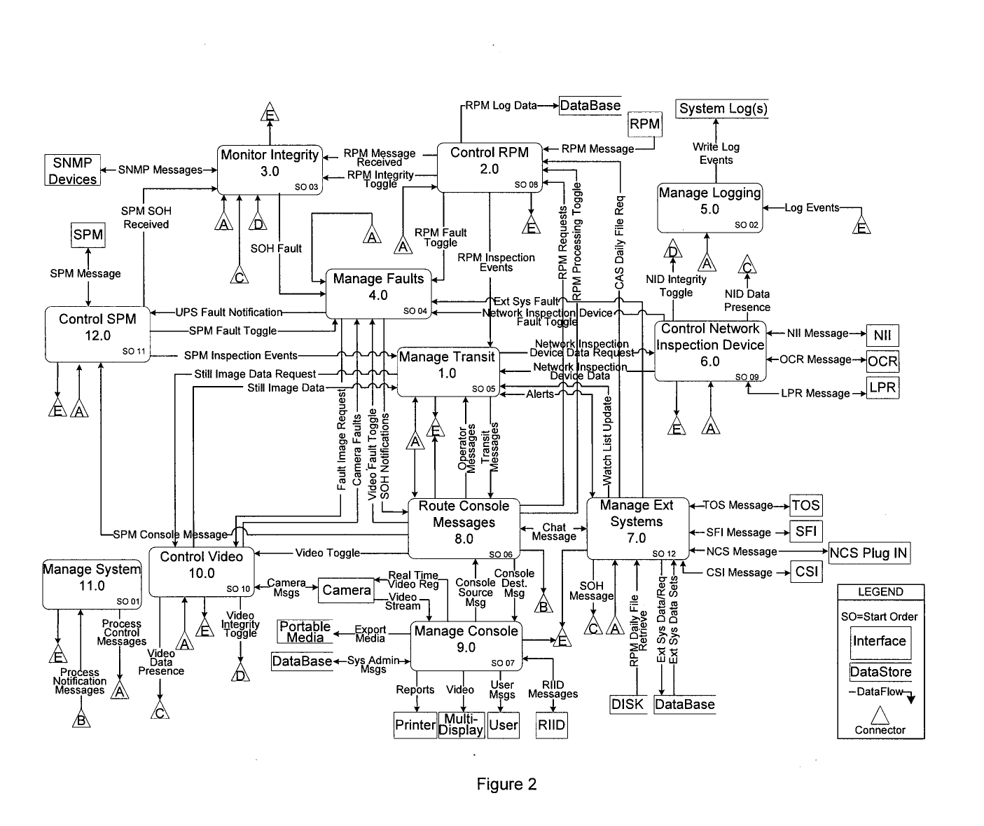

As shown now in reference to FIG. 2, which provides a CAS Core Component Operational Flow Diagram, it is seen how the CAS Plug-In System handles and processes the external interfaces, stores and retrieves the data from said interfaces into the Data Store, and handles the interface specific logic and business rules of which are then provided to the operator via the user interface. As various new interfaces, or Plug-Ins, are defined, a Control Interface and Manage Interface instance is created by the Core Component. The Control Interface objects are responsible for initiating data transfers to and from the device, setting interface specific operational parameters, and for sending actions to the interface. The Manage Interface objects execute the business rules and determines operational changes specific to the interface.

The specific data and associations necessary to support the external device are defined using the CAS Plug-In System ICD. When interfacing with the external device, the Core Component retrieves the interface specific business rules from the Data Store. Once retrieved and processed, the Manage Interface object directs the Control Interface objects to perform the appropriate action. The Control Interface object then sends the direction to the actual hardware device or external interface.

The CAS Plug-In System's unique design affords the ability to support other applications in a variety of industries. Industries that require the direct acquisition of data from multiple and non cross-compatible systems in real time will benefit from our technology. Additionally, industries that desire to automate, integrate, or analyze data from closed or proprietary third party devices. Examples would include food processing, medical, security, or agriculture industries.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A data management system comprising:
a) a data input interface capable of receiving a plurality of data streams pertaining to a surveillance event, wherein said data streams are derived from more than one data-generating collector;
b) data storage means capable of storing data from said plurality of data streams;
c) data analysis means capable of analyzing said data to characterize said event; and
d) a consumer interface capable of outputting said data in human recognizable form;
wherein said data input interface is configured to accommodate more than one dissimilar data streams from said more than one data-generating collectors.

2. The data management system of claim 1 wherein said consumer interface is configured to adjust the output of data from said more than one dissimilar data stream in recognizable form.

3. The data management system of claim 2 wherein said consumer interface is adapted to automatically output data from a new data stream.

4. The data management system of claim 2 further comprising a business logic component capable of determining the form of said output data.

5. The data management system of claim 1 wherein said consumer interface is configured to adjust the output of data from said more than one dissimilar data stream in recognizable form.

6. The data management system of claim 1 wherein said data input communication interface is designed to be modular.

7. The data management system of claim 6 wherein said modular data input communication interface can accept data streams derived from at least one additional data-generating collector.

8. The data management system of claim 1 wherein said data input communication interface is designed to accommodate a plurality of data-generating collectors of differing type or manufacture.

9. The data management system of claim 1 wherein said event constitutes the passage of a container through a port-of-entry.

10. The data management system of claim 1 wherein said event constitutes a step in a process.

11. The data management system of claim 1 wherein said more than one data-generating collectors comprise at least one collector of sensor data.

12. The data management system of claim 11 wherein said sensor data relates to a sensed attribute of a cargo container.

13. The data management system of claim 11 wherein at least one of said data-generating collectors is a data-generating collector selected from the group consisting of: a radiation identification device, a non-intrusive imaging device, a radiation portal monitor system, a terminal operating system, and an optical character recognition system.

14. The data management system of claim 1 wherein said data analysis means includes comparing data from at least two data streams.

15. The data management system of claim 1 wherein said event characterization relates to the security risk associated with said event.

16. The data management system of claim 1 wherein said data storage means is geographically remote from said data-generating collector.

17. The data management system of claim 1 wherein the addition of an additional data-generating collector requires modification of less than ten percent of the surveillance data management system software.

18. The data management system of claim 1 wherein the addition of an additional data-generating collector requires modification of less than five percent of the surveillance data management system software.

19. The data management system of claim 1 comprising at least about ten data-generating collectors.

20. The data management system of claim 1 comprising at least about fifty data-generating collectors.

21. The data management system of claim 1 comprising at least about one-hundred data-generating collectors.

22. The data management system of claim 1 comprising at least about one-thousand data-generating collectors.

23. A method for managing data streams of components of a system having more than one dissimilar data-generating collectors, said method comprising:
a) generating data from a communication interface capable of receiving a plurality of data streams pertaining to a surveillance event, wherein said data streams are derived from more than one data-generating collector;
b) inputting said generated data into data storage means capable of managing data from said plurality of data streams; and
c) performing data analysis of said data to characterize at least one detected attribute relating to said event from each of said plurality of data streams;
wherein said data input communication interface is capable of inputting more than one dissimilar data streams from said more than one data-generating collectors.

24. The method of claim 23, further comprising the step of characterizing said data utilizing a human recognizable interface.

25. The method of claim 23 wherein said data input communication interface is designed to be modular.

26. The method of claim 25 wherein said modular data input communication interface can accept data streams derived from at least one additional data-generating collector.

27. The method of claim 23 wherein said data input communication interface is designed to accommodate a plurality of data-generating collectors of differing type or manufacture.

28. The method of claim 23 wherein said event constitutes the passage of a container through a port-of-entry.

29. The method of claim 23 wherein said event constitutes a step in a process.

30. The method of claim 23 wherein said more than one data-generating collectors comprise at least one collector of sensor data.

31. The method of claim 30 wherein said sensor data relates to a sensed attribute of a cargo container.

32. The method of claim 30 wherein at least one of said data-generating collectors is a data-generating collector selected from the group consisting of: a radiation identification device, a non-intrusive imaging device, a radiation portal monitor system, a terminal operating system, and an optical character recognition system.

33. The method of claim 23 wherein said data analysis means includes comparing data from at least two data streams.

34. The method of claim 23 wherein said event characterization relates to the security risk associated with said event.

35. The method of claim 23 wherein said data storage means is geographically remote from said data-generating collector.
